(19) United States
(12) Patent Application Publication
(10) Pub. No.: US 2022/0123304 A1
(43) Pub. Date: Apr. 21, 2022

(54) COMPOSITE MATERIAL FOR ELECTRODE, METHOD OF FABRICATING THE SAME, AND ELECTRODE OF RECHARGEABLE BATTERY INCLUDING THE SAME

(71) Applicant: NATIONAL CHENG KUNG UNIVERSITY, Tainan City (TW)

(72) Inventors: CHUAN-PU LIU, Tainan City (TW); YIN-WEI CHENG, Kaohsiung City (TW); SHIH-AN WANG, Taipei City (TW); BO-LIANG PENG, Kaohsiung City (TW); CHUN-HUNG CHEN, New Taipei City (TW); JUN-HAN HUANG, Changhua County (TW); YI-CHANG LI, Changhua City (TW)

(21) Appl. No.: 16/888,808

(22) Filed: May 31, 2020

Related U.S. Application Data
(63) Continuation-in-part of application No. 16/206,812, filed on Nov. 30, 2018, now Pat. No. 11,063,253.

(51) Int. Cl. H01M 4/583; H01M 4/04

(52) U.S. Cl. CPC H01M 4/583; H01M 4/0416

(57) ABSTRACT

A composite material for electrode includes electrode composite particles, each of which includes a core and a shell. Each core includes carbon matrix, multiple active nanoparticles and multiple graphite particles. The active nanoparticles and the graphite particles are randomly dispersed in the carbon matrix. Each shell covers the surface of each core, and the Mohs hardness of the shell is greater than 2.

### CROSS REFERENCE OF RELATED APPLICATION

This is a Continuation-In-Part application that claims the benefit of priority under 35 U.S.C. § 120 to a non-provisional application, application Ser. No. 16/206,812, filed Nov. 30, 2018.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present disclosure relates generally to a material for an electrode of a rechargeable battery, and more particularly to a composite material for an electrode of a rechargeable battery, a method for fabricating the composite material, and a rechargeable battery electrode including the composite material.

### Description of Related Arts

Recently, rechargeable batteries have been applied in various technical fields. For example, lithium batteries have been widely used in electronic devices, vehicles, national defense, military and aerospace fields. Taking the lithium battery as an example, generally, the negative electrode of the lithium battery is made of graphite. However, due to a low capacity of graphite, a high capacity material and a composite of high capacity material and graphite have been developed to be used as negative electrode material.

The high capacity material may be silicon or metal oxide. However, the silicon and metal oxide easily expand during the charging and discharging process, which causes disintegration of the electrode structure. After several cycles of charging and discharging, the capacity of rechargeable battery will be greatly reduced. In order to extend the lifespan of rechargeable batteries, some manufacturers try to reduce the amount of high capacity material in the electrode, but the reduction of high capacity material is unfavorable for the improvement of capacity.

In addition, in order to increase the energy density of the rechargeable battery, a compaction process would generally be applied to an active material coating in the electrode to thereby increase the compaction density of the active material coating. However, during the compaction process, the high capacity material in the active material coating is prone to crack and become pulverized, which negatively affects the structural stability of the coating and reduces the capacity and lifespan of the rechargeable battery.

### SUMMARY OF THE PRESENT INVENTION

To this end, the present disclosure provides a composite material for an electrode, a method of fabricating the composite material, and a rechargeable battery including the composite material. The composite material for the electrode could meet the demand for an improved rechargeable battery with increased lifespan and capacity.

According to one embodiment of the present disclosure, a composite material for an electrode includes electrode composite particles, each of which includes a core and a shell. Each core includes carbon matrix, multiple active nanoparticles and multiple graphite particles. The active nanoparticles and the graphite particles are randomly dispersed in the carbon matrix. Each shell covers the surface of each core, and the Mohs hardness of the shell is greater than 2.

According to one embodiment of the present disclosure, each of the active nanoparticles includes an active material and a protective layer covering the active material, where the protective layer is an oxide, a carbide or a nitride of the active material.

According to one embodiment of the present disclosure, the active material is selected from the group consisting of group IVA elements, silver (Ag), zinc (Zn), aluminum (Al), arsenic (As), iron (Fe), cobalt (Co), nickel (Ni), copper (Cu), their metallic compounds, their alloys and combination thereof.

According to one embodiment of the present disclosure, the protective layer in each of the active nanoparticles contacts the active material covering by the protective layer without any gap therebetween.

According to one embodiment of the present disclosure, the volume percentage of the protective layer in each of the active nanoparticles is smaller than 23.0%.

According to one embodiment of the present disclosure, the volume percentage of the protective layer in each of the active nanoparticles is smaller than or equal to 10.0%.

According to one embodiment of the present disclosure, the active nanoparticles of each of the electrode composite particles contact the carbon matrix without any gap therebetween.

According to one embodiment of the present disclosure, the shells are metals or ceramics.

According to one embodiment of the present disclosure, the shells are gold (Au), silicon oxycarbide (SiOC), titanium nitride (TiN), or a combination thereof.

According to one embodiment of the present disclosure, the shell of each of the electrode composite particles conformally covers the core.

According to one embodiment of the present disclosure, the shell of each of the electrode composite particles directly contacts the carbon matrix of the core.

According to one embodiment of the present disclosure, the thickness of the shell of each of the electrode composite particles is from 50 nm to 2 μm.

According to one embodiment of the present disclosure, the surface of the core of each of the electrode composite particles is partially exposed from the shell.

According to one embodiment of the present disclosure, a rechargeable battery electrode including the above composite material for the electrode is provided.

According to one embodiment of the present disclosure, a method of fabricating a composite material for an electrode is provided and includes the following steps. First, multiple first electrode composite particles are provided, where each of the first electrode composite particles are made of a carbon matrix, multiple active nanoparticles randomly dispersed in the carbon matrix, and multiple graphite particles randomly dispersed in the carbon matrix. Then, a shell is formed on the surface of each of the first electrode composite particles to thereby form multiple second electrode composite particles, where the Mohs hardness of the shell is greater than 2. Finally, a compaction process is performed on the second electrode composite particles to thereby increase a compaction density of all of the second electrode composite particles.

According to one embodiment of the present disclosure, the contact areas among the second electrode composite particles are increased by performing the compaction process on the second electrode composite particles.

According to the present disclosure, when the active nanoparticles expand during a charging reaction, the protective layer is provided as a buffer to prevent cracks of the composite particle due to a compressive force between the expanded active nanoparticles and the surrounding carbon matrix. Furthermore, since the volume percentage of the protective layer in the active nanoparticle is within a proper range, it is favorable for preventing high electrical resistance and low charge/discharge capacity of the composite material due to overly thick protective layer, thereby meeting the requirements of high capacity and crack resistant structure. On the other hand, since the shells covering the cores have the Mohs hardness higher than 2, the shells could effectively withstand the external forces applied during the compaction process without excessive deformation. As a result, the cores of the composite material would not be cracked or pulverized when the compaction process is completed.

It will be apparent to those skilled in the art that various modifications and variations may be made to the present disclosure. It is intended that the specification and examples be considered as exemplary embodiments only, with a scope of the disclosure being indicated by the following claims and their equivalents.

### BRIEF DESCRIPTION OF THE DRAWINGS

The above and other objects, features and advantages of the present invention will be apparent from the following detailed description of the embodiments of the invention in conjunction with the accompanying drawings, in which:

FIG. 1 is a schematic cross-sectional diagram of a composite material for an electrode according to one embodiment of the present disclosure;

FIG. 2 is a schematic cross-sectional diagram of a composite material for an electrode according to one embodiment of the present disclosure;

FIG. 3 is a schematic cross-sectional diagram of a composite material for an electrode, where an electrode composite particle of the composite material includes a core and a shell according to one embodiment of the present disclosure;

FIG. 4 is a schematic diagram of an appearance of an electrode composite particle according to one embodiment of the present disclosure;

FIG. 5 is a schematic cross-sectional diagram of a rechargeable battery according to one embodiment of the present disclosure;

FIG. 6 is an SEM image of a composite material for an electrode according to one embodiment of the present disclosure;

FIG. 7 (a) is an SEM image of a composite material for an electrode before a compaction process according to some embodiments of the present disclosure;

FIG. 7 (b) is an SEM image of a composite material for an electrode after a compaction process according to some embodiments of the present disclosure;

FIG. 8 (a) is an SEM image of a composite material for an electrode before a compaction process according to some embodiments of the present disclosure;

FIG. 8 (h) is an SEM image of a composite material for an electrode after a compaction process according to some embodiments of the present disclosure;

FIG. 9 (a) is an SEM image of composite material for an electrode before a compaction process according to some embodiments of the present disclosure;

FIG. 9 (b) is an SEM image of composite material for an electrode after a compaction process according to some embodiments of the present disclosure;

FIG. 10 (a) is an SEM image of composite material for an electrode before a compaction process according to some embodiments of the present disclosure; and

FIG. 10 (b) is an SEM image of composite material for an electrode after a compaction process according to some embodiments of the present disclosure.

### DETAILED DESCRIPTION OF THE PREFERRED EMBODIMENT

In the following detailed description, for purposes of explanation, numerous specific details are set forth in order to provide a thorough understanding of the disclosed embodiments. The detailed description provided below in connection with the appended drawings is intended as a description of the embodiments and is not intended to represent the only forms in which the present embodiments may be constructed or utilized.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the respective testing measurements. Also, as used herein, the term “about” generally means in 10%, 5%, 1%, or 0.5% of a given value or range. Alternatively, the term “about” means in an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the term “about.” Accordingly, unless indicated to the contrary, the numerical parameters set forth in the present disclosure and attached claims are approximations that may vary as desired. At the very least, each numerical parameter should at least be construed in light of the number of reported significant digits and by applying ordinary rounding techniques. Ranges may be expressed herein as from one endpoint to another endpoint or between two endpoints. All ranges disclosed herein are inclusive of the endpoints, unless specified otherwise.

Unless otherwise defined herein, scientific and technical terminologies employed in the present disclosure shall have the meanings that are commonly understood and used by one of ordinary skill in the art. Unless otherwise required by context, it will be understood that singular terms shall include plural forms of the same and plural terms shall include the singular. Specifically, as used herein and in the claims, the singular forms “a” and “an” include the plural reference unless the context clearly indicates otherwise.

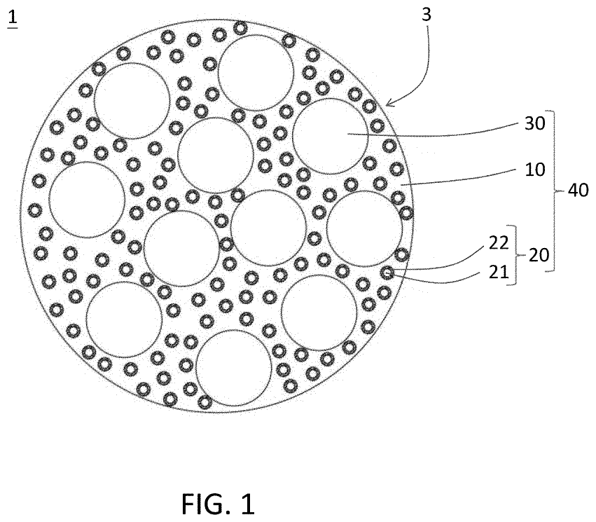

FIG. 1 is a schematic view of a composite material for an electrode according to one embodiment of the present disclosure. Referring to FIG. 1, in this embodiment, a composite material for an electrode (also called a composite material 1) may include at least multiple composite particles 3, optional adhesive agents, and optional electrical conductive agents, but not limited thereto. The composite particle 3 may include a core 40 containing a carbon matrix 10, multiple active nanoparticles 20 and multiple graphite particles 30. The active nanoparticles 20 are randomly dispersed in the carbon matrix 10, and each of the active nanoparticles 20 includes an active material 21 and a protective layer 22. The protective layer 22 covers the active material 21. The protective layer 22 is an oxide, a carbide or a nitride of the active material 21. The graphite particles 30 are randomly dispersed in the carbon matrix 10.

According to one embodiment of the present disclosure, the carbon matrix 10, for example but not limited to, is amorphous carbon matrix or amorphous carbon nitride matrix. The active nanoparticle 20, for example but not limited to, is a nanoparticle including group IVA elements or transition elements.

According to one embodiment of the present disclosure, the volume percentage of the protective layer 22 in each active nanoparticle 20 is smaller than 23.0%. More specifically, when the volume of a single active nanoparticle 20 is V₀, the volume of the protective layer 22 of the single active nanoparticle 20 is V, and the volume percentage V/V₀ is smaller than 23.0%. Therefore, when the active material 21 expands in a charging reaction, the protective layer 22 is provided as a buffer to prevent cracks of the electrode composite particle 3 due to a compressive force between the expanded active material 21 and the carbon matrix 10. Also, since the volume percentage of the protective layer 22 in the active nanoparticle 20 is within a proper range, it is favorable for preventing high electrical resistance and low capacity (charge/discharge capacity) of the electrode composite particle 3 due to overly thick protective layer 22, thereby meeting the requirements of high capacity and crack resistant structure. Preferably, in some embodiments, the volume percentage of the protective layer in each active nanoparticle is smaller than 10.0%.

According to one embodiment of the present disclosure, an average particle size of the electrode composite particle 3 is from 500.0 nanometers (nm) to 40.0 micrometers (μm). Therefore, an electrode plate made of the electrode composite particles 3 features high compaction density, high structural strength and high Coulombic efficiency, such that it is favorable for increasing the lifespan of a battery including the electrode plate. A electrode composite particle with an average particle size smaller than 500.0 nm has overly high specific surface area so as to cause the decrease of Coulombic efficiency. An electrode plate made of multiple electrode composite particles with an average particle size larger than 40.0 μm has insufficient structural strength such that the lifespan of the battery will decay rapidly. Preferably, in some embodiments, an average particle size of the electrode composite particle 3 is from 500.0 nm to 30.0 μm.

According to one embodiment of the present disclosure, an average particle size of each of the active nanoparticles 20 is from 1.0 nm to 500.0 nm. Therefore, it is favorable for balancing the requirements of crack resistant structure and high capacity.

According to one embodiment of the present disclosure, an average particle size of each of the graphite particles 30 is from 300.0 nm to 30.0 μm. Therefore, it is favorable for the graphite particle 30 having a specific surface area which is suitable for providing high electric conductivity. It is also favorable for preventing improper volume of the electrode composite particle 3 due to overly large graphite particles 30.

According to one embodiment of the present disclosure, the thickness of the protective layer 22 in each active nanoparticle 20 is equal to or smaller than 10.0 nm. Therefore, it is favorable for preventing high resistance and low capacity of the electrode composite particle 3 due to overly thick protective layer 22, thereby meeting the requirements of high capacity and crack resistant structure.

According to one embodiment of the present disclosure, the active material 21 of the active nanoparticle 20 is selected from the group consisting of group IVA elements, silver (Ag), zinc (Zn), aluminum (Al), arsenic (As), iron (Fe), cobalt (Co), nickel (Ni), copper (Cu), their metallic compounds, their alloys and combination thereof. Therefore, it is favorable for providing high capacity of the battery.

According to one embodiment of the present disclosure, the carbon matrix 10 contacts each of the active nanoparticles 20, and there is no gap between the carbon matrix 10 and the active nanoparticles 20. Therefore, without any gap between the carbon matrix 10 and the active nanoparticle 20, it is favorable for accommodating more active nanoparticles 20 in per unit volume of the electrode composite particle 3, thereby enhancing the capacity.

According to one embodiment of the present disclosure, in each active nanoparticle 20, the protective layer 22 contacts the active material 21, and there is no gap between the active material 21 and the protective layer 22. Therefore, without any gap between the active material 21 and the protective layer 22 in each active nanoparticle 20, it is favorable for obtaining good electric charge transport path between the active material 21 and the carbon matrix 10.

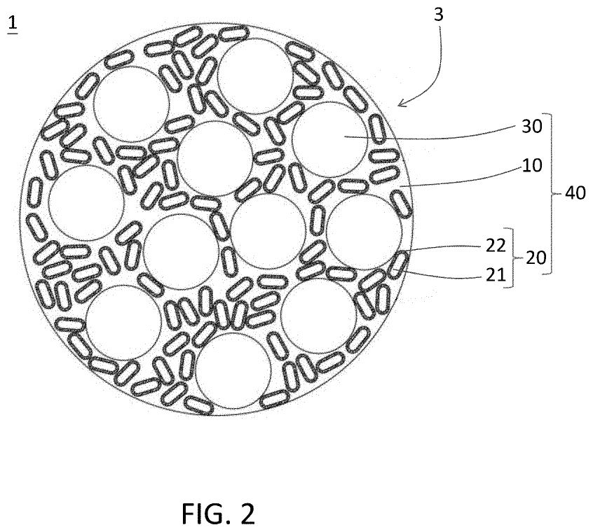

According to one embodiment of the present disclosure, each of the active nanoparticles 20 is in a shape of sphere. Therefore, it is favorable for homogenizing the volume change of the electrode composite particle 3, such that a uniform electrochemical property in per unit volume of the electrode plate made of the electrode composite particles 3 is achieved. A spherical active nanoparticle 20 is shown in FIG. 1, but the present disclosure is not limited thereto. FIG. 2 is a schematic view of a composite particle for electrode according to another embodiment of the present disclosure, where the active nanoparticle 20 is in a shape of bar or sheet.

According to one embodiment of the present disclosure, a volume ratio of the active nanoparticles 20 to a total of the carbon matrix 10 and the graphite particles 30 (a ratio of the volume of the active nanoparticles 20 to the sum of volumes of the carbon matrix 10 and the graphite particles 30) is from 1:9 to 9:1. More specifically, when the volume of all active nanoparticles 20 in the electrode composite particle 3 is V1, the volume of the carbon matrix 10 is V2, the volume of all graphite particles 30 in the electrode composite particle 3 is V3, and V1:(V2+V3) is from 1:9 to 9:1. Therefore, it is favorable for the electrode composite particle 3 having high capacity.

According to one embodiment of the present disclosure, the volume of the graphite particle 30 is larger than the volume of the active nanoparticle 20. Therefore, it is favorable for reducing the influence of volume change of the active nanoparticles on the structure of the electrode composite particle 3.

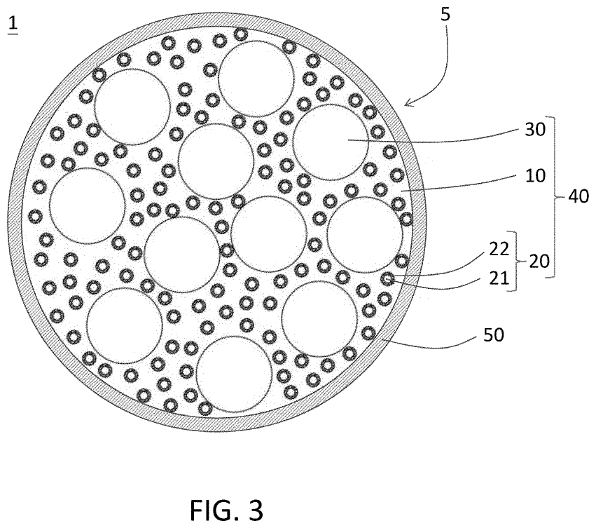

According to one embodiment of the present disclosure, a shell having a Mohs hardness greater than 2 may be further disposed on the surfaces of the electrode composite particles 3, such as a shell having a Mohs hardness of 2.0, 2.1, 2.5, 3.0, 3.5, 4.0, 4.5, or 5.0, to protect the electrode composite particles 3 from cracking or pulverizing. According to the present disclosure, the phrase “Mohs hardness greater than 2” disclosed herein should be interpreted as “a Mohs hardness being at least 2.0 (including 2.0)”. FIG. 3 is a schematic cross-sectional diagram of a composite material for an electrode. Referring to FIG. 3, an electrode composite particle 5 of the composite material 1 may include a core 40 and a shell 50. Since the composition, ratio, and configuration of the core 40 are similar to those described in the above embodiments, the detailed description of which is omitted for the sake of clarity. The shell 50 covers the surface of the core 40, and the Mohs hardness of the shell 50 is greater than 2. According to one embodiment of the present disclosure, the shell 50 is a metal or ceramic with a Mohs hardness higher than 2, such as gold, silicon oxycarbide (SiOₓC₁₋ₓ), titanium nitride, or a combination thereof, but not limited thereto. According to one embodiment of the present disclosure, the thickness of the shell 50 is from 50 nm to 2 μm, but it is not limited thereto. The shell 50 may directly contact the carbon matrix 10 in the core 40 and may conformally cover part or the entire surface of the core 40, but not limited thereto.

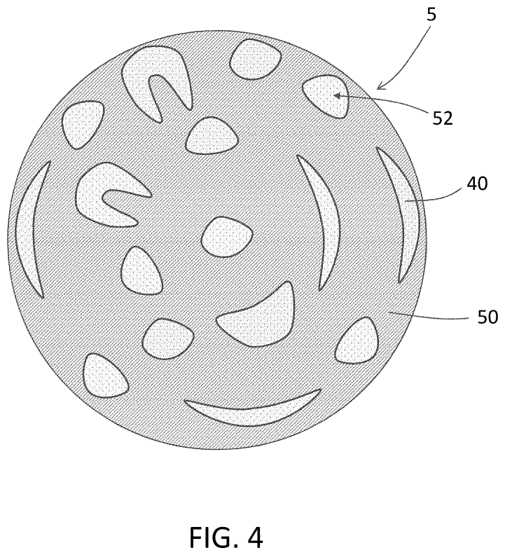

FIG. 4 is a schematic view showing the appearance of an electrode composite particle according to one embodiment of the present disclosure. Referring to FIG. 4, the shell 50 of each electrode composite particle 5 may include multiple pores 52 so that part of the surface of the core 40 may be exposed from the shell 50. By providing multiple pores 52 in the shell 50, metal ions, such as lithium ions, in the electrolyte may enter and exit the core 40 more easily, so that the capacity density of the battery may be improved. Furthermore, the shapes and distribution of the pores 52 in the shell 50 are not limited to those shown in FIG. 4. According to one embodiment of the present disclosure, the pores 52 may also be connected in series, so that the pores 52 may be continuously distributed on the surface of the core 40, and the shell 50 is intermittently distributed on the surface of the core 40.

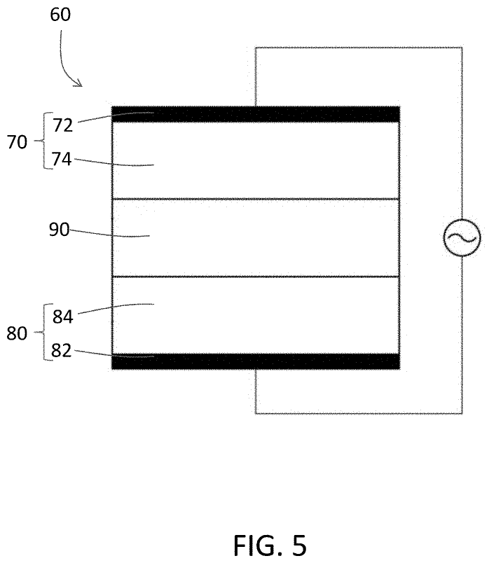

According to one embodiment of the present disclosure, the electrode composite particle 3 and 5 is applicable to a battery electrode. FIG. 5 is a schematic view of a rechargeable battery according to one embodiment of the present disclosure. Referring to FIG. 5, a rechargeable battery 60, for example but not limited thereto, is a lithium-ion battery including a negative electrode 70, a positive electrode 80 and a separator 90. The negative electrode 70 includes a conductive plate 72 and an active material coating 74, where the active material coating 74 may include the above composite material 1. The positive electrode 80 includes a conductive plate 82 and an active material coating 84, wherein the active material coating 84 may include lithium cobalt oxide (LiCoO₂), lithium manganate (LiMn₂O₄), lithium nickelate (LiNiO₂) or lithium iron phosphate (LiFePO₄) and so forth, but not limited thereto. The separator 90 is disposed between the negative electrode 70 and the positive electrode 80. The separator 90, for example but not limited to, is a polyethylene film, a polypropylene film, an alumina film, a silicon dioxide film, a titanium dioxide film, a calcium carbonate film or a solid electrolyte. In some embodiments, an electrolyte, e.g. LiPF₆-based electrolyte, is existed between the negative electrode 70 and the positive electrode 80.

Its order to enable a person having ordinary skill in the art to implement the present disclosure, the specific examples regarding a method of fabricating electrode composite particles are further elaborated below. It should be noted, however, that the following examples are for illustrative purposes only and should not be construed to limit the present disclosure. That is, the materials, amounts and ratios of the materials, and the processing flow in the respective examples may be appropriately modified so long as these modifications are within the spirit and scope of the present disclosure as defined by the appended claims.

### Example 1

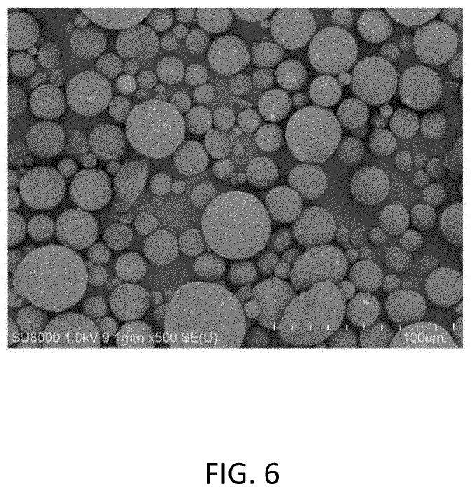

According to one embodiment of the present disclosure, a method of manufacturing composite particle is disclosed. First, several amount of silicon nanoparticle powder is mixed with an aqueous solution (for example, Milli-Q water), and several amount of carboxymethyl cellulose (CMC) is added. The mixture is stirred to make the substances uniformly distributed. Then, several amount of graphite powder is further added, and the stirring is continued until the silicon nanoparticle powder, the CMC and the graphite powder are uniformly dispersed in the aqueous solution to obtain a composite material mixture. The above composite material mixture is granulated by spray granulation, and the granulated particles have a particle size from 500.0 nm to 40.0 μm. The granulated particles are placed in a high temperature furnace continuously supplied with inert gas. The granulated particles are continuously heated for several hours at a temperature of 700° C. to 1000° C. to form electrode composite particles 3. FIG. 6 is an SEM image of electrode composite particles according to one embodiment of the present disclosure.

### Example 2

Another embodiment of the present disclosure discloses a method of manufacturing electrode composite particles. First, several amount of silicon nanoparticle powder is mixed with N-Methyl-2-Pyrrolidone (NMP) solution, and several amount of polyimide is added. The mixture is stirred to make the substances uniformly distributed. Then, several amount of graphite powder is further added, and the stirring is continued until the silicon nanoparticle powder, the polyimide and the graphite powder are uniformly dispersed in the NMP solution to obtain a composite material mixture. The above composite material mixture is granulated by spray granulation, and the granulated particles have a particle size from 500.0 nm to 40.0 μm. The granulated particles are placed in a high temperature furnace continuously supplied with inert gas. The granulated particles are continuously heated for several hours at a temperature of 700° C. to 1000° C. to form electrode composite particles 3.

### Example 3

First, based on the processes in above Example 1 or Example 2, electrode composite particles 3 (or called first electrode composite particles) with an average particle size of 20.0 microns are prepared, each of which includes a carbon matrix, multiple active nanoparticles with an average particle size of 200.0 nanometers, and multiple graphite particles with an average particle size of 350.0 nanometers. The active nanoparticle includes a silicon core (active material) and a silicon oxide film (protective layer) covering the silicon core, and the active nanoparticles are spherical. The volume ratio of the active nano particles to a total of the carbon matrixes and the graphite particles is 9:1. Then, 10 g of the powder of the first electrode composite particles was placed in a 4-inch holder in the magnetron sputtering machine, and gold (Au) was used as the target in a magnetron sputtering process. By performing the magnetron sputtering process, electrode composite particles 5 (or called second electrode composite particles) having a shell (i.e. Au layer) could be obtained. During the sputtering process, the stage loaded with the first electrode composite material powder could be heated, rotated and vibrated. The working energy of the above magnetron sputtering process is 50 W, working pressure is 1*10⁻² torr, working gas is Argon, gas flow rate is 10 sccm, vibration frequency of the stage is 1 kHz, rotation speed of the stage is 10 rpm, and sputtering duration is 1 hour.

### Example 4

First, based on the processes in above Example 1 or Example 2, electrode composite particles 3 (or called first electrode composite particles) with an average particle size of 20.0 microns are prepared, each of which includes a carbon matrix, multiple active nanoparticles with an average particle size of 200.0 nanometers, and multiple graphite particles with an average particle size of 350.0 nanometers. The active nanoparticle includes a silicon core (active material) and a silicon oxide film (protective layer) covering the silicon core, and the active nanoparticles are spherical. The volume ratio of the active nano particles to a total of the carbon matrixes and the graphite particles is 9:1. Then, 10 g of the powder of the first electrode composite particles was placed in a 4-inch holder in the magnetron sputtering machine, and silicon oxycarbide (SiO_{0.5}C_{0.5}) was used as the target in a magnetron sputtering process. By performing the magnetron sputtering process, electrode composite particles 5 (or called second electrode composite particles) having a shell (i.e. SiOₓC₁₋ₓ, 0<x<1) could be obtained. During the sputtering process, the stage loaded with the first electrode composite material powder could be heated, rotated and vibrated. The working energy of the above magnetron sputtering process is 150 W, working pressure is 1*10⁻² torr, working gas is Argon, gas flow rate is 10 sccm, vibration frequency of the stage is 1 kHz, rotation speed of the stage is 10 rpm, and sputtering duration is 1 hour.

### Example 5

First, based on the processes in above Example 1 or Example 2, electrode composite particles 3 (or called first electrode composite particles) with an average particle size of 20.0 microns are prepared, each of which includes a carbon matrix, multiple active nanoparticles with an average particle size of 200.0 nanometers, and multiple graphite particles with an average particle size of 350.0 nanometers. The active nanoparticle includes a silicon core (active material) and a silicon oxide film (protective layer) covering the silicon core, and the active nanoparticles are spherical. The volume ratio of the active nano particles to a total of the carbon matrixes and the graphite particles is 9:1. Then, 10 g of the powder of the first electrode composite particles was placed in a 4-inch holder in the magnetron sputtering machine, and Titanium nitride (TiN) was used as the target in a magnetron sputtering process. By performing the magnetron sputtering process, electrode composite particles 5 (or called second electrode composite particles) having a shell (i.e. TiN) could be obtained. During the sputtering process, the stage loaded with the first electrode composite material powder could be heated, rotated and vibrated. The working energy of the above magnetron sputtering process is 200 W, working pressure is 1*10⁻² torr, working gas is Argon, gas flow rate is 8 sccm, vibration frequency of the stage is 1 kHz, rotation speed of the stage is 10 rpm, and sputtering duration is 1 hour.

The effect of the compositions and ratios of the active nanoparticles 20, protective layers 22, and the shells 50 on the physical and electrical characteristics of the electrode composite particles 3 and 5 may be further tested. The characterizations disclosed below include: influence of silicon in the composite particle on capacity, influence of the volume percentage of protective layer in active nanoparticle on capacity, influence of the shape of active nanoparticle on capacity, and influence of the shell on capacity.

{Influence of Silicon in the Composite Particle on Capacity}

### Exemplary Embodiment 1

Electrode composite particles 3, manufactured by either of the methods in accordance with Example 1 and Example 2, have an average particle size of 38.0 μm. The electrode composite particle 3 includes a carbon matrix, multiple active nanoparticles with an average particle size of 500.0 nm, and multiple graphitic particles with an average particle size of 2.0 μm. The active nanoparticle includes a silicon core (active material) and a silicon oxide film (protective layer) covering the silicon core. The active nanoparticle is in a shape of sphere. The volume ratio of the active nanoparticles to a total of the carbon matrix and the graphite particles is 1:9.

### Exemplary Embodiment 2

Electrode composite particles 3, manufactured by either of the methods in accordance with Example 1 and Example 2, have an average particle size of 25.0 μm. The composite particle includes a carbon matrix, multiple active nanoparticles with an average particle size of 200.0 nm, and multiple graphitic particles with an average particle size of 650 nm. The active nanoparticle includes a silicon core (active material) and a silicon oxide film (protective layer) covering the silicon core. The active nanoparticle is in a shape of sphere. The volume ratio of the active nanoparticles to a total of the carbon matrix and the graphite particles is 1:1.

### Exemplary Embodiment 3

Electrode composite particles 3, manufactured by either of the methods in accordance with Example 1 and Example 2, have an average particle size of 20.0 μm. The composite particle includes a carbon matrix, multiple active nanoparticles with an average particle size of 200.0 nm, and multiple graphitic particles with an average particle size of 350 nm. The active nanoparticle includes a silicon core (active material) and a silicon oxide film (protective layer) covering the silicon core. The active nanoparticle is in a shape of sphere. The volume ratio of the active nanoparticles to a total of the carbon matrix and the graphite particles is 9:1.

A negative electrode for rechargeable battery may be further fabricated, where the negative electrode may contain any one of the electrode composite particles 3 in accordance with above Exemplary Embodiments 1-3 without the addition of graphite additives. For the rechargeable battery including each negative electrode, after several cycles of charging and discharging under the same current density, the electrochemical properties are shown in TABLE 1 below.

TABLE 1

| | Embodi- | Embodi- | Embodi- |
|---|---|---|---|
| | ment 1 | ment 2 | ment 3 |
| Volume ratio of active nanoparticles | 1:9 | 1:1 | 9:1 |
| to a total of carbon matrix and | | | |
| graphite particles | | | |
| Capacity at 1 C discharge rate | 520 | 1210 | 1912 |
| (mAh/g) | | | |
| Coulombic efficiency (%) | 90.8 | 87 | 82 |
| Capacity retention after 200 cycles | 95 | 90 | 83 |
| (%) | | | |

According to TABLE 1, the electrode composite particles in the Exemplary Embodiment 1 through the Embodiment 3 have the advantages of high capacity, high Coulombic efficiency and high cycle life. In addition, the composite particle in the Exemplary Embodiment 3, with higher content of silicon, has higher capacity. Furthermore, the protective layer of the active nanoparticle is taken as a buffer to prevent cracks of the active nanoparticle due to excessive expansion of the silicon core. Therefore, compared with the conventional electrode material with high content of silicon, the composite particle in the Embodiment 3 shows high Coulombic efficiency and high cycle life.

{Influence of the Volume Percentage of Protective Layer in Active Nanoparticle on Capacity}

### Exemplary Embodiment 4

Electrode composite particles 3, manufactured by either of the methods in accordance with Example 1 and Example 2, have an average particle size of 30.0 run. The electrode composite particle 3 includes a carbon matrix, multiple active nanoparticles with an average particle size of 700.0 nm, and multiple graphitic particles with an average particle size of 1.0 μm. The active nanoparticle includes a silicon core (active material) and a silicon oxide film (protective layer) covering the silicon core. The active nanoparticle is in a shape of sphere, and the thickness of the silicon oxide film is 30.0 nm. The volume ratio of the active nanoparticles to a total of the carbon matrix and the graphite particles is 9:1.

### Exemplary Embodiment 5

Electrode composite particles 3, manufactured by either of the methods in accordance with Example 1 and Example 2, have an average particle size of 30.0 μm. The electrode composite particle 3 includes a carbon matrix, multiple active nanoparticles with an average particle size of 700.0 nm, and multiple graphitic particles with an average particle size of 1.0 μm. The active nanoparticle includes a silicon core (active material) and a silicon nitride film (protective layer) covering the silicon core. The active nanoparticle is in a shape of sphere, and the thickness of the silicon nitride film is 30.0 nm. The volume ratio of the active nanoparticles to a total of the carbon matrix and the graphite particles is 9:1.

### Exemplary Embodiment 6

Electrode composite particles 3, manufactured by either of the methods in accordance with Example 1 and Example 2, have an average particle size of 25.0 μm. The electrode composite particle includes a carbon matrix, multiple active nanoparticles with an average particle size of 250.0 nm, and multiple graphitic particles with an average particle size of 800.0 nm. The active nanoparticle includes a silicon core (active material) and a silicon oxide film (protective layer) covering the silicon core. The active nanoparticle is in a shape of sphere, and the thickness of the silicon oxide film is 10.0 nm. The volume ratio of the active nanoparticles to a total of the carbon matrix and the graphite particles is 9:1.

### Exemplary Embodiment 7

Electrode composite particles 3, manufactured by either of the methods in accordance with Example 1 and Example 2, have an average particle size of 25.0 μm. The electrode composite particle includes a carbon matrix, multiple active nanoparticles with an average particle size of 250.0 nm, and multiple graphitic particles with an average particle size of 800.0 nm. The active nanoparticle includes a silicon core (active material) and a silicon nitride film (protective layer) covering the silicon core. The active nanoparticle is in a shape of sphere, and the thickness of the silicon nitride film is 10.0 nm. The volume ratio of the active nanoparticles to a total of the carbon matrix and the graphite particles is 9:1.

A negative electrode for a rechargeable battery may be further fabricated, where the negative electrode may contain any one of the electrode composite particles 3 in accordance with above Exemplary Embodiments 4-7 without the addition of graphite additives. For the rechargeable battery including each negative electrode, after several cycles of charging and discharging under the same current density, the electrochemical properties are shown in TABLE 2 below.

TABLE 2

| | Embodi- | Embodi- | Embodi- | Embodi- |
|---|---|---|---|---|
| | ment 4 | ment 5 | ment 6 | ment 7 |
| Material of protective | Silicon | Silicon | Silicon | Silicon |
| layer | oxide | nitride | oxide | nitride |
| Volume fraction of | 23 | 23 | 10 | 10 |
| protective layer in | | | | |
| active nanoparticle (%) | | | | |
| Capacity at 1 C discharge | 1760 | 1850 | 2500 | 2570 |
| rate (mAh/g) | | | | |
| Coulombic efficiency | 71 | 73 | 84 | 85 |
| (%) | | | | |

According to TABLE 2, the electrode composite particles in the Exemplary Embodiment 4 through the Exemplary Embodiment 7 have the advantages of high capacity and high Coulombic efficiency. In addition, the composite particles in the Exemplary Embodiment 6 and the Exemplary Embodiment 7, with smaller volume percentage of the protective layer in the active nanoparticle, show a capacity and a Coulombic efficiency higher than the composite particles in the Exemplary Embodiment 4 and the Exemplary Embodiment 5.

{Influence of the Shape of Active Nanoparticle on Capacity}

### Exemplary Embodiment 8

Electrode composite particles 3, manufactured by either of the methods in accordance with Example 1 and Example 2, have an average particle size of 20.0 μm. The electrode composite particle includes a carbon matrix, multiple active nanoparticles with an average particle size of 200.0 nm, and multiple graphitic particles with an average particle size of 350.0 nm. The active nanoparticle includes a silicon core (active material) and a silicon oxide film (protective layer) covering the silicon core. The active nanoparticle is in a shape of sphere.

### Exemplary Embodiment 9

Electrode composite particles 3, manufactured by either of the methods in accordance with Example 1 and Example 2, have an average particle size of 20.0 μm. The electrode composite particle includes a carbon matrix, multiple active nanoparticles with an average particle size of 200.0 nm, and multiple graphitic particles with an average particle size of 350.0 nm. The active nanoparticle includes a silicon core (active material) and a silicon oxide film (protective layer) covering the silicon core. The active nanoparticle is in a shape of sheet.

A negative electrode for a rechargeable battery may be further fabricated, where the negative electrode may contain any one of the electrode composite particles 3 in accordance with above Exemplary Embodiments 8 and 9 without the addition of graphite additives. For the rechargeable battery including any one of the above negative electrodes, after several cycles of charging and discharging under the same current density, the electrochemical properties are shown in TABLE 3 below.

TABLE 3

| | Embodiment 8 | Embodiment 9 |
|---|---|---|
| Shape of active nanoparticle | Sphere | Sheet |
| Capacity at 1 C discharge rate | 2570 | 2490 |
| (mAh/g) | | |
| Coulombic efficiency (%) | 85 | 82 |

According to TABLE 3, the electrode composite particle in the Exemplary Embodiment 8 shows higher capacity and higher Coulombic efficiency than the electrode composite particle in the Exemplary Embodiment 9.

{Influence of the Shell on Capacity}

### Exemplary Embodiment 10

Electrode composite particles 3, manufactured by either of the methods in accordance with Example 1 and Example 2, have an average particle size of 20.0 μm. The electrode composite particle includes a carbon matrix, multiple active nanoparticles with an average particle size of 200.0 nm, and multiple graphitic particles with an average particle size of 350.0 nm. The active nanoparticle includes a silicon core (active material) and a silicon oxide film (protective layer) covering the silicon core.

### Exemplary Embodiments 11-13

Exemplary Embodiments 11-13 respectively correspond to the electrode composite particles 5 of Examples 3-5.

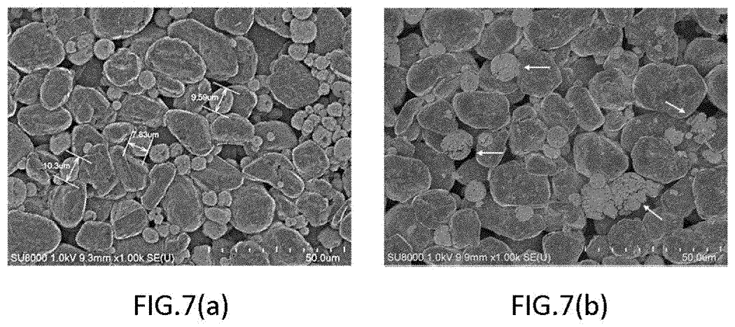

The electrode composite particles 3 of the above Exemplary Embodiment 10 and the electrode composite particles 5 of the Exemplary Embodiments 11 to 13 may be subject to a compaction process. The original (i.e. un-compacted) and compacted electrode composite particles 3 and 5 may respectively act as ingredients of a negative electrode for a rechargeable battery. Several measurements may be carried out for the rechargeable battery containing either of the electrode composite particles 3 and 5 without the addition of graphite additives. The measurements include electronic microscope inspection, Mohs hardness measurement, resistance measurement, measurement on discharge capacity density (1C), and measurement on capacity retention rate (200 cycles). The results are shown in FIGS. 7(a), 7(b), 8(a), 8(b), 9(a), 9(b), 10(a), 10(b) and TABLE 4 below.

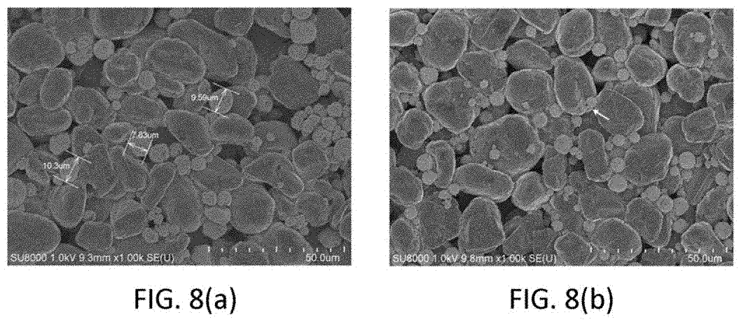

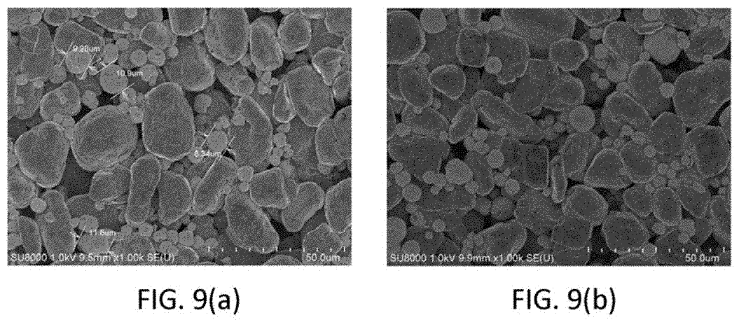

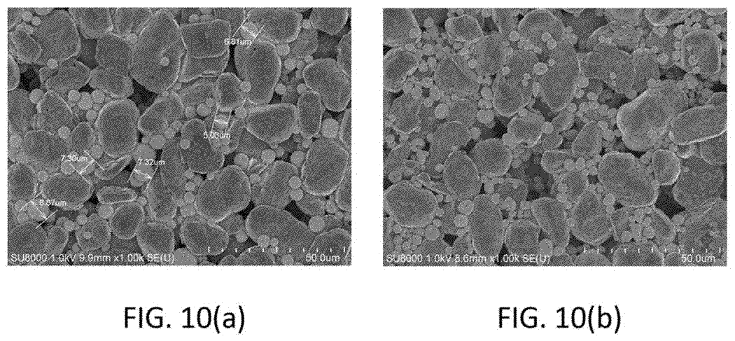

TABLE 4

| | Embodiment 10 | | Embodiment 11 | | Embodiment 12 | | Embodiment 13 | |
|---|---|---|---|---|---|---|---|---|
| | before* | after^{⊚} | before | after | before | after | before | after |
| Material of shell | N.A. | | Au | | SiOₓC₁₋ₓ | | TiN | |
| Appearance | FIG. 7 | FIG. 7 | FIG. 8 | FIG. 8 | FIG. 9 | FIG. 9 | FIG. 10 | FIG. 10 |
| | (a) | (b) | (a) | (b) | (a) | (b) | (a) | (b) |
| Mohs hardness | 1.5 | | 2.5 | | 6.8 | | 9 | |
| Compact density | 1.3 | 1.7 | 1.3 | 1.7 | 1.3 | 1.7 | 1.3 | 1.7 |
| (g/c.c.) | | | | | | | | |
| Resistance (Ω) | 36 | 37.8 | 35.87 | 29.94 | 38.78 | 34.44 | 37.78 | 33.38 |
| Capacity at 1 C | 1912 | 1950 | 1850 | 1890 | 1650 | 1670 | 1780 | 1800 |
| discharge rate | | | | | | | | |
| (mAh/g) | | | | | | | | |
| Capacity-retention | 85 | 62 | 87 | 80 | 92 | 85 | 90 | 87 |
| rate (%) | | | | | | | | |

*“before” means “before a compaction process is applied to the electrode composite particles”
^{⊚}“after” means “after a compaction process is applied to the electrode composite particles”

According to TABLE 4, before the compaction process is conducted, the electrode composite particles 5 with the shell (Exemplary Embodiments 11 and 12) have relatively high resistance and relatively low capacity density compared with the electrode composite particles 3 without the shell (Exemplary Embodiment 10). However, the capacity retention rate (i.e. capacity after numeral charge/discharge cycles) of Exemplary Embodiments 11 and 12 is relatively high compared with that of Exemplary Embodiment 10. Thus, the electrode composite particles 5 with the shell have better structure stability, which is critical to and favorable for long cycle life.

In addition, after the compaction process is conducted, portions of the electrode composite particles 3 without the shell may be cracked and pulverized (see regions indicated by the arrows in FIG. 7(b)), which causes an increase in the electrical resistance and a significant decrease in the capacity retention rate (i.e. down to 62%). In contrast, after the electrode composite material particles 5 are subject to the compaction process, only a few cracks may be observed, and most of the electrode composite particles 5 are not cracked or pulverized (refer to FIG. 8(b), FIG. 9(b), and FIG. 10(b)). Therefore, it demonstrates that the electrode composite particles 5 with the shell may withstand the pressure applying during the compaction process. In addition, after the compaction process, the capacity of electrode composite particles 5 in accordance with each Exemplary Embodiment is slightly increased. The reason of the increase in the capacity may be that the contact between the electrode composite particles is enhanced, which leads to the reduction in the contact resistance.

According to the present disclosure, when the active nanoparticles expand during a charging reaction, the protective layer is provided as a buffer to prevent cracks of the composite particle due to a compressive force between the expanded active nanoparticles and the surrounding carbon matrix. Furthermore, since the volume percentage of the protective layer in the active nanoparticle is within a proper range, it is favorable for preventing high electrical resistance and low charge/discharge capacity of the composite material due to overly thick protective layer, thereby meeting the requirements of high capacity and crack resistant structure. On the other hand, since the shells covering the cores have the Mohs hardness greater than 2, the shells could effectively withstand the external forces without excessive deformation during the compaction process. As a result, the cores of the composite material would not be cracked or pulverized when the compaction process is completed.

It will be apparent to those skilled in the art that various modifications and variations may be made to the present disclosure. It is intended that the specification and examples be considered as exemplary embodiments only, with a scope of the disclosure being indicated by the following claims and their equivalents.

What is claimed is:

1. A composite material for an electrode, comprising:
a plurality of electrode composite particles, wherein each of the electrode composite particles comprises:
a core, comprising:
a carbon matrix;
a plurality of active nanoparticles randomly dispersed in the carbon matrix; and
a plurality of graphite particles randomly dispersed in the carbon matrix; and
a shell covering a surface of the core, wherein Mohs hardness of the shell is greater than 2.

2. The composite material for the electrode, as recited in claim 1, wherein each of the active nanoparticles comprises an active material and a protective layer covering the active material, wherein the protective layer is an oxide, a carbide or a nitride of the active material.

3. The composite material for the electrode, as recited in claim 2, wherein the active material is selected from the group consisting of group IVA elements, silver (Ag), zinc (Zn), aluminum (Al), arsenic (As), iron (Fe), cobalt (Co), nickel (Ni), copper (Cu), their metallic compounds, their alloys and combination thereof.

4. The composite material for the electrode, as recited in claim 2, wherein the protective layer in each of the active nanoparticles contacts the active material covering by the protective layer without any gap therebetween.

5. The composite material for the electrode, as recited in claim 2, wherein a volume percentage of the protective layer in each of the active nanoparticles is smaller than 23.0%.

6. The composite material for the electrode, as recited in claim 2, wherein the volume percentage of the protective layer in each of the active nanoparticles is smaller than or equal to 10.0%.

7. The composite material for the electrode, as recited in claim 1, wherein the active nanoparticles in each of the electrode composite particles contact the carbon matrix without any gap therebetween.

8. The composite material for the electrode, as recited in claim 1, wherein the shells are metals or ceramics.

9. The composite material for the electrode, as recited in claim 1, wherein the shells are gold (Au), silicon oxycarbide (SiOC), titanium nitride (TiN), or a combination thereof.

10. The composite material for the electrode, as recited in claim 1, wherein the shell of each of the electrode composite particles conformally covers the core.

11. The composite material for the electrode, as recited in claim 1, wherein the shell of each of the electrode composite particles directly contacts the carbon matrix of the core.

12. The composite material for the electrode, as recited in claim 1, wherein a thickness of the shell of each of the electrode composite particles is from 50 nm to 2 μm.

13. The composite material for the electrode, as recited in claim 1, wherein a surface of the core of each of the electrode composite particles is partially exposed from the shell.

14. A rechargeable battery electrode, comprising the composite material for the electrode according to claim 1.

15. A method of fabricating a composite material for an electrode, comprising:
providing a plurality of first electrode composite particles, wherein each of the first electrode composite particles comprises:
a carbon matrix;
a plurality of active nanoparticles randomly dispersed in the carbon matrix; and
a plurality of graphite particles randomly dispersed in the carbon matrix;
forming a shell on a surface of each of the first electrode composite particles to thereby form a plurality of second electrode composite particles, wherein Mohs hardness of the shell is greater than 2; and
performing a compaction process on the second electrode composite particles to thereby increase a compaction density of all of the second electrode composite particles.

16. The method of fabricating the composite material for the electrode, as recited in claim 15, wherein each of the active nanoparticles comprises an active material and a protective layer covering the active material, wherein the protective layer is an oxide, a carbide or a nitride of the active material.

17. The method of fabricating the composite material for the electrode, as recited in claim 15, wherein contact areas among the second electrode composite particles are increased by performing the compaction process on the second electrode composite particles.

18. The method of fabricating the composite material for the electrode, as recited in claim 15, wherein the shells are gold (Au), silicon oxycarbide (SiOC), titanium nitride (TiN), or a combination thereof.
